(19) United States
(12) Patent Application Publication
(10) Pub. No.: US 2017/0242195 A1
(43) Pub. Date: Aug. 24, 2017

(54) MULTI-CHANNEL INTEGRATED OPTICAL WAVELENGTH DIVISION MULTIPLEXING/DEMULTIPLEXING ASSEMBLY STRUCTURE

(71) Applicant: WUHAN TELECOMMUNICATION DEVICES CO., LTD., Wuhan City, Hubei Province (CN)

(72) Inventors: Xuefeng LIN, Wuhan City, Hubei Province (CN); Baiquan HU, Wuhan City, Hubei Province (CN); Chenggang LIU, Wuhan City, Hubei Province (CN); Xianghong YU, Wuhan City, Hubei Province (CN)

(21) Appl. No.: 15/503,566

(22) PCT Filed: Dec. 19, 2014
(86) PCT No.: PCT/CN2014/094329

§ 371 Date: Feb. 13, 2017

(30) Foreign Application Priority Data
Jun. 11, 2014 (CN) 201410255328.8

(51) Int. Cl. G02B 6/293; G02B 6/12; G02B 6/30; G02B 6/32

(52) U.S. Cl. CPC G02B 6/29367; G02B 6/2938; G02B 6/32; G02B 6/12007; G02B 6/30

(57) ABSTRACT

The present invention provides a multi-channel integrated optical wavelength division multiplexing/demultiplexing assembly structure, comprising a light transmitting assembly and a light receiving assembly, the light transmitting assembly consisting of a laser chip array, a coupling lens set, a wavelength division multiplexing assembly, a single coupling lens and a single-core optical fiber, wherein the wavelength division multiplexing assembly comprises an optical waveguide chip, a band-pass filter set, a full-wavelength reflection unit, and multiple segments of waveguide optical paths that are continuously distributed in the optical waveguide chip in a Z-shape or W-shape, each of the multiple segments of waveguide optical paths has an input port and an output port which are distributed on left and right sides of the optical waveguide chip, respectively, the output ports comprise a tail end port which is arranged in correspondence to the single coupling lens, the band-pass filter set covers the input ports, and the full-wavelength reflection unit covers the output ports other than the tail end port. With the combination of the foregoing structure configurations, the technical problem of the presence of accuracy offset of the overall optical path is solved, and the effects of easy assembly, reduced cost and improved product yield are realized.

### TECHNICAL FIELD

The present invention relates to the technical field of optical communication, and in particular to a multi-channel integrated optical wavelength division multiplexing/demultiplexing assembly structure.

### BACKGROUND OF THE PRESENT INVENTION

With the rapid growth of the demand of modern communication on bandwidth, the requirements proposed by optical communication systems on high-speed optical transceiver module and on the light transmitting assemblies and the light receiving assemblies in the module are enhanced increasingly. The following main development trends are shown: higher rate, smaller size of the optical transceiver modules and lower power consumption.

At present, the rate of semiconductor lasers is limited by the bottlenecks of semiconductor and photoelectricity technology, and the rate of single-channel commercial products cannot be increased for the moment. In order to improve the transmission capacity of optical communication equipments per unit volume, high-speed optical transceiver modules currently, mainly by packaging a multi-channel semiconductor laser/detector array into a light transmitting/receiving assembly with only one optical port for input/output by using optical wavelength division multiplexing/demultiplexing technology, improves the transmission rate of the single-ended optical port. For example, for the light transmitting/receiving assembly in a 40 Gbps QSFP+ optical transceiver module, four 10 Gbps lasers/detector chips of different CWDM wavelengths are coupled to a single optical fiber by optical wavelength division multiplexing/demultiplexing technology, so that 40 Gbps signals are transmitted by the single optical fiber. Although the size of the 40 Gbps QSFP+ optical transceiver module is slightly larger than that of a conventional 10 Gbps SFP+ optical transceiver module, the transmission rate of the 40 Gbps QSFP+ optical transceiver module is four times of that of the conventional 10 Gbps SFP+ optical transceiver module. The Institute of Electrical and Electronic Engineers (IEEE) has deployed and formulated related standards for this novel high-speed network protocol. The 40 Gbps and 100 Gbps Ethernet standards under the P802.3ba engineering task force have been issued, and the 400 Gbps standards are being formulated.

The key technique for the light transmitting/receiving assembly with a multi-channel integrated optical wavelength division multiplexing/demultiplexing function is how to realize the optical wavelength division multiplexing/demultiplexing function inside an assembly of a very small volume. It is required to realize not only efficient optical coupling of all the channels but also the small-size packaging to meet the requirements on the size of the optical transceiver module.

A technical solution mainly adopted in the art at present is shown in FIG. 1. For a light transmitting assembly, a laser array 101 is a multi-channel array consisting of a plurality of laser chips of different wavelengths. There may be 4, 12, 16 or any other number of channels (description is given by using 4 channels as an example in the present patent), and the spacing between the channels has to be equal strictly. The pass-band wavelength of a band-pass filter set 103 corresponds to the wavelength of each channel of the lasers. The band-pass filter set 103 may transmit the wavelengths within the pass-band and reflect the wavelengths out of the pass-band. A full reflecting mirror 105 reflects light of all wavelengths. A glass substrate 104 is made of glass with excellent light transmittance or other transparent materials, and has two planes which have very high requirements on the degree of parallelism and the distance tolerance.

The band-pass filter set 103 is mounted on one plane of the glass substrate 104, and the full reflecting mirror 105 is mounted on the other plane of the glass substrate 104. The lights emitted from the laser array 101 pass through a collimating lens set 102 to become multiple channels of parallel collimated lights. The multiple channels of collimated lights are obliquely incident onto the band-pass filter set 103 at a certain incident angle and then transmitted into the glass substrate 104. After the reflection by the full reflecting mirror 105 and the reflection by the band-pass filter set 103 for the lights of non-pass-band wavelengths, the lights go forward on the glass substrate in a Z-shape or W-shape. The special optical path is shown by the “arrows” in FIG. 1. Finally the light beams from all the channels are basically overlapped at an exit of the glass substrate 104, then incident onto a coupling lens 106, and coupled into an optical fiber 107. According to the requirements on the assembly performance, an optical isolator may be additionally provided between the coupling lens 106 and the optical fiber 107.

For the light receiving assembly, the principle of the structure is basically the same as that of FIG. 1, except for that the laser array 101 is replaced by a detector array. The lights of multiple different wavelengths is emergent from the optical fiber 107, and then go forward in the reverse direction of the optical path indicated by the arrows in FIG. 1, and finally the plurality of optical paths of different wavelengths are split and coupled into the detector array to enter the respective channels.

The key of the light transmitting/receiving assembly structure with a multi-channel integrated optical wavelength division multiplexing/demultiplexing function lies in that the optical paths of all the channels must be overlapped in the front of the coupling lens 106 as much as possible, so that the coupling of the lights from all the channels with the optical fiber has a higher coupling efficiency by using one coupling lens 106, in order to meet the requirements on the performance of the light assembly. Since the glass substrate does not restrict the light beams, the control to the overall optical path is mainly determined by the positions of the band-pass filter set 103 and the full reflecting mirror 105. Therefore, such a Z-shaped or W-shaped optical path is very sensitive to the angle to and from the reflecting planes and the distance between them. For example, if there is an included angle of 0.3 degrees between the two surfaces of the glass substrate or the distance between the two surfaces is offset by a dozen of micrometers from the target value, the light beam from the last channel and the multiple light beams from the first channel are likely to generate an offset of a dozen or dozens of micrometers, so that the two channels have a great difference in the optical coupling efficiency. In addition, the offset in the degree of parallelism and the spacing of the multiple channels of collimated lights will also make the light beams from all the channels unable to be overlapped well finally. Hence, the spacing between the channels, the mounting position of the collimating lens set, the collimation degree of the collimated lights and other related factors have a great influence on the overall optical path and the final performance of the light assembly. In an assembly with a great number of channels, due to the longer optical path, the same accuracy offset will lead to a larger offset of the final optical path. In conclusion, the conventional light transmitting/receiving assembly structure with a multi-channel integrated optical wavelength division multiplexing/demultiplexing function has very strict requirements on the machining tolerance of the related materials and the mounting accuracy, and consequently, the material cost and the production cost are increased greatly. Moreover, in the actual assembly production process, due to the inevitable influences from the material tolerance and the process accuracy, the yield of products with all the channels qualified is also influenced greatly.

### SUMMARY OF THE PRESENT INVENTION

### Technical Problem

To solve the above technical problems, a main objective of the present invention is to provide a multi-channel integrated optical wavelength division multiplexing/demultiplexing assembly structure, which solves the technical problems in the prior art of very strict requirements on the material machining tolerance and the accuracy of the assembly mounting process, and high difficulty and low product yield in the coupling process.

### Technical Solutions

The present invention employs the following technical solutions. The present invention provides a multi-channel integrated optical wavelength division multiplexing/demultiplexing assembly structure, comprising a light transmitting assembly and a light receiving assembly, the light transmitting assembly consisting of a laser chip array, a coupling lens set, a wavelength division multiplexing assembly, a single coupling lens and a single-core optical fiber, wherein the wavelength division multiplexing assembly is arranged between the coupling lens set and the single coupling lens and comprises an optical waveguide chip, a band-pass filter set, a full-wavelength reflection unit and multiple segments of waveguide optical paths that are continuously distributed in the optical waveguide chip in a Z-shape or W-shape, each of the multiple segments of waveguide optical paths has an input port and an output port which are distributed on left and right sides of the optical waveguide chip, respectively, the output ports comprise a tail end port which is arranged in correspondence to the single coupling lens, the band-pass filter set covers the input ports, and the full-wavelength reflection unit covers the output ports other than the tail end port.

In a preferred embodiment of the present invention, the laser chip array has light emitting units, wherein the laser chip array is an array formed by a plurality of discrete laser chips of different wavelengths or an array formed by a single laser chip having a plurality of light emitting units of different wavelengths, and the light emitting units are arranged on a same straight line equidistantly or arranged on a same straight line non-equidistantly and at any intervals.

In a preferred embodiment of the present invention, the coupling lens set is an array formed by a plurality of discrete lenses or an array formed by a single lens having a plurality of lens units.

In a preferred embodiment of the present invention, the light transmitting assembly further comprises an optical isolator which is provided at a position between the single coupling lens and the single-core optical fiber assembly.

In a preferred embodiment of the present invention, the light receiving assembly comprises a detector chip array, a demultiplexing assembly, a single coupling lens and a single-core optical fiber.

In a preferred embodiment of the present invention, the demultiplexing assembly comprises an optical waveguide chip, a band-pass filter set, a full-wavelength reflection unit and multiple segments of waveguide optical paths that are continuously distributed in the optical waveguide chip in a Z-shape or W-shape, each of the multiple segments of waveguide optical paths has an input port and an output port which are distributed on left and right sides of the optical waveguide chip, respectively, the output ports comprise a tail end port which is arranged in correspondence to the single coupling lens, the band-pass filter set covers the input ports, and the full-wavelength reflection unit covers the output ports other than the tail end port.

In a preferred embodiment of the present invention, the light receiving assembly further comprises a coupling lens set which is provided at a position between the detector chip array and the demultiplexing assembly.

In a preferred embodiment of the present invention, the detector chip array is an array formed by a plurality of discrete detector chips or an array formed by a single detector chip having a plurality of detector units, wherein the operating wavelength of each channel of the detector chip array corresponds to that of the laser chip array.

In a preferred embodiment of the present invention, the optical waveguide chip comprises a substrate, a core layer, an upper cladding and a lower cladding, wherein the core layer is made of germanium-doped silicon dioxide or pure silicon; and, both the upper cladding and the lower cladding are made of pure silicon dioxide, or the upper cladding is air and the lower cladding is made of silicon dioxide.

In a preferred embodiment of the present invention, the single-core optical fiber comprises a ceramic ferrule with an optical fiber or a glass assembly with an optical fiber.

In a preferred embodiment of the present invention, the full-wavelength reflection unit is a coating layer having a reflection function or a reflecting mirror.

In a preferred embodiment of the present invention, the optical waveguide chip is of a shape of a parallelogram block.

In a preferred embodiment of the present invention, the multiple segments of waveguide optical paths are multiple segments of straight waveguides or multiple segments of curved waveguides which are continuously distributed in a Z-shape or W-shape.

In a preferred embodiment of the present invention, the spacing between the input ports may be an equal distance or any unequal distances, and the spacing between the output ports may be an equal distance or any unequal distances.

In a preferred embodiment of the present invention, the widths of the multiple segments of waveguide optical paths are the same or different.

### Advantageous Effects

Compared with the prior art, the present invention has the following advantageous effects: by limiting the multi-channel optical paths inside a light assembly by using an optical waveguide chip, the size machining tolerance and the mounting accuracy tolerance of each assembly are increased, so that the product yield, particularly the product yield of a light assembly with a great number of channels, is obviously improved. Accordingly, the productivity of light assemblies may be improved effectively, and the cost of light assemblies may be reduced.

### BRIEF DESCRIPTION OF THE DRAWINGS

FIG. 1 is a structural diagram of a light transmitting assembly with a multi-channel integrated optical wavelength division multiplexing function in the prior art;

FIG. 2 is a structural diagram of a preferred embodiment of the present invention;

FIG. 3 is a structural diagram of the optical wavelength division multiplexing/demultiplexing assembly of FIG. 2;

FIG. 4 is a structural diagram of another preferred embodiment of the light transmitting assembly; and

FIG. 5 is a structural diagram of another preferred embodiment of the light receiving assembly.

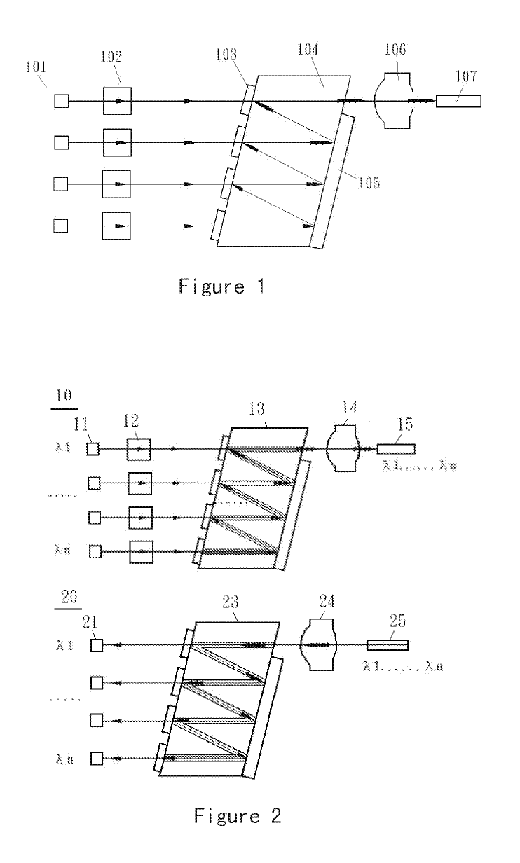

### DETAILED DESCRIPTION OF THE PRESENT INVENTION

The present invention will be further described below with reference to the accompanying drawings.

With reference to FIG. 2, the present invention provides a multi-channel integrated optical wavelength division multiplexing/demultiplexing assembly structure, comprising a light transmitting assembly 10 and a light receiving assembly 20.

In that, the light transmitting assembly 10 consists of a laser chip array 11, a coupling lens set 12, a wavelength division multiplexing assembly 13, a single coupling lens 14 and a single-core optical fiber 15, wherein the laser chip array 11 may be an array formed by a plurality of discrete laser chips of different wavelengths or a laser chip array having a plurality of light emitting units of different wavelengths; the wavelengths of the channels may be different CWDM, LWDM or DWDM wavelengths meeting the IEEE specifications, or may be any other wavelengths; and, the number n of the array channels may be 4, 6 or any other number. Of course, the effective light emitting units of the laser chip array 11 may be arranged on a same straight line equidistantly, or may be arranged on a same straight line non-equidistantly and at any intervals. The coupling lens set 12 may be an array formed by a plurality of discrete lenses, or may be a single lens array having a plurality of lens units. The wavelength division multiplexing assembly 13 is arranged between the coupling lens set 12 and the single coupling lens 14. The single-core optical fiber 15 is a bare optical fiber, a ceramic ferrule with an optical fiber or a glass assembly with an optical fiber. The light receiving assembly 20 consists of a detector chip array 21, a demultiplexing assembly 23, a single coupling lens 24 and a single-core optical fiber 25, wherein the detector chip array 21 may be an array formed by a plurality of discrete detector chips, or may be a single detector chip array having a plurality of detector units; the operating wavelengths of the detector chips of the channels correspond to those of the channels of the laser chip array 11; the demultiplexing assembly 23 is mounted on the left side to the detector chip array 21; and the single coupling lens 24 is mounted between the demultiplexing assembly 23 and the single-core optical fiber 25. In an embodiment of the present invention, multi-channel light beams emitted from the laser chip array 10 pass through the coupling lens set 12, then are incident onto the optical wavelength division multiplexing assembly 13 at a certain incident angle, are emergent from an output waveguide port O1 at the tail end, and enter the single-core optical fiber assembly 15 through the single coupling lens 14.

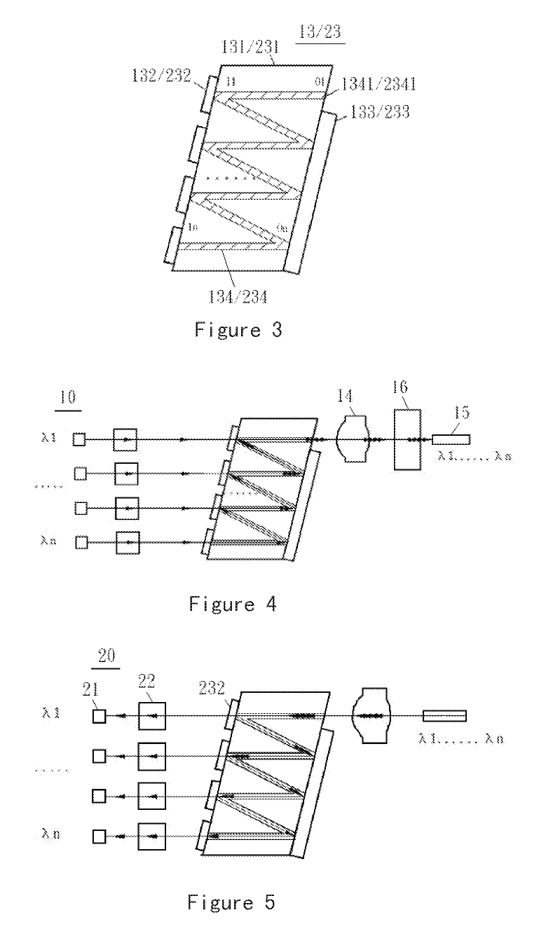

With reference to FIGS. 3 and 4, in an embodiment of the present invention, an optical isolator 16 is further provided between the single coupling lens 14 and the single-core optical fiber assembly 15 of the light transmitting assembly 10. During operation, a light beam incident onto the optical wavelength division multiplexing assembly 13 is emergent to the single coupling lens 14 via the output waveguide port O1, and then enters the single-core optical fiber 15 from the optical isolator 16.

With reference to FIGS. 3 and 5, in an embodiment of the present invention, a coupling lens set 22 is further provided between the detector chip array 21 and the demultiplexing assembly 23. During operation, the light beams emergent from the single-core optical fiber 25 of the light receiving assembly 20 contain a plurality of light beams of different wavelengths. The light beams enter the output waveguide port O1 at the tail end after passing through and being coupled by the single coupling lens 24. Then, the light beams of different wavelengths are emergent from corresponding input waveguide ports, and coupled into the detector chip array 21 through the coupling lens set 22, individually.

Returning to FIG. 2 and with reference to FIG. 3, in an embodiment of the present invention, the wavelength division multiplexing assembly 13 and the demultiplexing assembly 23 (hereinafter referred to as “division multiplexing/demultiplexing assembly for short) are assemblies of the same structure. The single coupling lens 24 and the single coupling lens 14 in the light transmitting assembly 10 are assemblies of the same structure, and the single-core optical fiber 25 and the single-core optical fiber 15 in the light transmitting assembly 10 are also assemblies of the same structure. The division multiplexing/demultiplexing assembly 13/23 comprises an optical waveguide chip 131/231, a band-pass filter set 132/232, a full-wavelength reflection unit 133/233 and waveguide optical paths 134/234.

In that, the optical waveguide chip 131/231 is of a shape of a parallelogram block, and has multiple segments of waveguide optical paths 134/234. The core layers of the multiple segments of waveguide optical paths are continuously distributed in a Z-shape or W-shape (as shown by the shaded portion in FIG. 3). n input waveguide ports I1 . . . In and output waveguide ports O1 . . . On (hereinafter referred to as “input and output ports” for short) are provided on the left and right sides of the optical waveguide chip 131/231, respectively, where n is the number of the channels of the light transmitting/receiving assembly with a multi-channel integrated optical wavelength division multiplexing/demultiplexing function. In this embodiment, the multiple segments of waveguide optical paths 134/234 may be multiple segments of straight waveguides which are continuously distributed in a Z-shape or W-shape, or may be multiple segments of curved waveguides which are continuously distributed in a Z-shape or W-shape. The spacings between adjacent input ports or output ports may be an equal distance or any unequal distances. In this embodiment, the widths of the multiple segments of waveguide optical paths are the same or different. For example, a spot size converter (SSC) is used at the input or output waveguide ports. The optical waveguide chip 131/231 may be made of any waveguide material for a conventional process, for example, a silicon-based silicon dioxide material, in which the substrate is silicon, the core layer is germanium-doped silicon dioxide, and the upper cladding and the lower cladding are pure silicon, and the transverse section size of the core layer waveguide satisfies the conditions for single-mode waveguide transmission. As another example, the optical waveguide chip 131/231 may be made of a silicon-on-insulator material, with the substrate being made of silicon, the lower cladding being made of silicon dioxide, the core layer being made of pure silicon, and the upper cladding being air or being made of silicon dioxide, and the transverse section size of the core layer waveguide satisfies the conditions for single-mode transmission.

The band-pass filter set 132/232 comprises n filters of different pass-bands. Each pass-band wavelength corresponds to the operating wavelength of each channel of the multi-channel light transmitting/receiving assembly. The band-pass filter set 132/232 can transmit the wavelengths within the pass-bands, and reflect the wavelengths out of the pass-bands. The band-pass filter set 132/232 is mounted to and covers then input ports on the respective left side of the waveguide chip 131/231. The full-wavelength reflection unit 133/233 is a reflecting mirror capable of reflecting all the operating wavelengths, and is mounted to and covers the n-1 output waveguide ports other than the output waveguide port 1341/2341 at the tail end on the respective right side of the optical waveguide chip 131/132. In this embodiment, the full-wavelength reflection unit 133/233 may also be a coating layer having a reflection function. In this embodiment, when the lights of different wavelengths from the n channels enter the respective input or output ports of the waveguide optical paths, due to the reflection of the band-pass filter set 132/232 for the wavelengths out of the pass-band and the reflection of the full-wavelength reflection unit 133/233, the light beams successively enter the next waveguide for propagation along the Z-shaped or W-shaped waveguide optical paths. Due to the restricting to the direction of propagation of the light beams by the optical waveguide, the lights from the n channels are eventually emergent or incident from or into the output waveguide port 1341/2341 at the tail end.

In conclusion, the forgoing description merely shows preferred embodiments of the present invention and is not intended to limit the protection scope of the present invention. Any equivalent variation and modification made in accordance with the scope of the present invention patent and the contents described in the description shall fall into the scope of the present invention patent.

1. A multi-channel integrated optical wavelength division multiplexing/demultiplexing assembly structure, comprising a light transmitting assembly and a light receiving assembly, the light transmitting assembly consisting of a laser chip array, a coupling lens set, a wavelength division multiplexing assembly, a single coupling lens and a single-core optical fiber, characterized in that the wavelength division multiplexing assembly is arranged between the coupling lens set and the single coupling lens and comprises an optical waveguide chip, a band-pass filter set, a full-wavelength reflection unit and multiple segments of waveguide optical paths that are continuously distributed in the optical waveguide chip in a Z-shape or W-shape, each of the multiple segments of waveguide optical paths has an input port and an output port which are distributed on left and right sides of the optical waveguide chip, respectively, the output ports comprise a tail end port which is arranged in correspondence to the single coupling lens, the band-pass filter set covers the input ports, and the full-wavelength reflection unit covers the output ports other than the tail end port.

2. The multi-channel integrated optical wavelength division multiplexing/demultiplexing assembly structure according to claim 1, wherein the laser chip array has light emitting units, wherein the laser chip array is an array formed by a plurality of discrete laser chips of different wavelengths or an array formed by a single laser chip having a plurality of light emitting units of different wavelengths, and the light emitting units are arranged on a same straight line equidistantly or arranged on a same straight line non-equidistantly and at any intervals.

3. The multi-channel integrated optical wavelength division multiplexing/demultiplexing assembly structure according to claim 2, wherein the coupling lens set is an array formed by a plurality of discrete lenses or an array formed by a single lens having a plurality of lens units.

4. The multi-channel integrated optical wavelength division multiplexing/demultiplexing assembly structure according to claim 3, wherein the light transmitting assembly further comprises an optical isolator which is provided at a position between the single coupling lens and the single-core optical fiber assembly.

5. The multi-channel integrated optical wavelength division multiplexing/demultiplexing assembly structure according to claim 1, wherein the light receiving assembly comprises a detector chip array, a demultiplexing assembly, a single coupling lens and a single-core optical fiber.

6. The multi-channel integrated optical wavelength division multiplexing/demultiplexing assembly structure according to claim 5, wherein the demultiplexing assembly comprises an optical waveguide chip, a band-pass filter set, a full-wavelength reflection unit and multiple segments of waveguide optical paths that are continuously distributed in the optical waveguide chip in a Z-shape or W-shape, each of the multiple segments of waveguide optical paths has an input port and an output port which are distributed on left and right sides of the optical waveguide chip, respectively, the output ports comprise a tail end port which is arranged in correspondence to the single coupling lens, the band-pass filter set covers the input ports, and the full-wavelength reflection unit covers the output ports other than the tail end port.

7. The multi-channel integrated optical wavelength division multiplexing/demultiplexing assembly structure according to claim 6, wherein the light receiving assembly further comprises a coupling lens set which is provided at a position between the detector chip array and the demultiplexing assembly.

8. The multi-channel integrated optical wavelength division multiplexing/demultiplexing assembly structure according to claim 7, wherein the detector chip array is an array formed by a plurality of discrete detector chips or an array formed by a single detector chip having a plurality of detector units, wherein the operating wavelength of each channel of the detector chip array corresponds to that of the laser chip array.

9. The multi-channel integrated optical wavelength division multiplexing/demultiplexing assembly structure according to claim 1, wherein the optical waveguide chip comprises a substrate, a core layer, an upper cladding and a lower cladding, wherein the core layer is made of germanium-doped silicon dioxide or pure silicon; and, both the upper cladding and the lower cladding are made of pure silicon dioxide, or the upper cladding is air and the lower cladding is made of silicon dioxide.

10. The multi-channel integrated optical wavelength division multiplexing/demultiplexing assembly structure according to claim 1, wherein the single-core optical fiber comprises a ceramic ferrule with an optical fiber or a glass assembly with an optical fiber.

11. The multi-channel integrated optical wavelength division multiplexing/demultiplexing assembly structure according to claim 1, wherein the full-wavelength reflection unit is a coating layer having a reflection function or a reflecting mirror.

12. The multi-channel integrated optical wavelength division multiplexing/demultiplexing assembly structure according to claim 1, wherein the optical waveguide chip is of a shape of a parallelogram block.

13. The multi-channel integrated optical wavelength division multiplexing/demultiplexing assembly structure according to claim 6, wherein the optical waveguide chip comprises a substrate, a core layer, an upper cladding and a lower cladding, wherein the core layer is made of germanium-doped silicon dioxide or pure silicon; and, both the upper cladding and the lower cladding are made of pure silicon dioxide, or the upper cladding is air and the lower cladding is made of silicon dioxide.

14. The multi-channel integrated optical wavelength division multiplexing/demultiplexing assembly structure according to claim 6, wherein the single-core optical fiber comprises a ceramic ferrule with an optical fiber or a glass assembly with an optical fiber.

15. The multi-channel integrated optical wavelength division multiplexing/demultiplexing assembly structure according to claim 6, wherein the full-wavelength reflection unit is a coating layer having a reflection function or a reflecting mirror.

16. The multi-channel integrated optical wavelength division multiplexing/demultiplexing assembly structure according to claim 6, wherein the optical waveguide chip is of a shape of a parallelogram block.
